(19) United States
(12) Patent Application Publication
(10) Pub. No.: US 2026/0342162 A1
(43) Pub. Date: Oct. 29, 2026

(54) STATOR OF A DYNAMOELECTRIC MACHINE WITH ANTI-FRICTION LAYER ON SLOT OPENINGS

(71) Applicant: Innomotics GmbH, 90441 Nürnberg (DE)

(72) Inventors: KLAUS BÜTTNER, Hollstadt (DE); TOBIAS KATZENBERGER, Bad Königshofen STT Unteressfeld (DE); KLAUS KIRCHNER, Ostheim (DE); BASTIAN PLOCHMANN, Neustadt an der Aisch (DE); MATTHIAS WARMUTH, Windshausen (DE)

(73) Assignee: Innomotics GmbH, 90441 Nürnberg (DE)

(21) Appl. No.: 19/119,658

(22) PCT Filed: Jul. 5, 2023
(86) PCT No.: PCT/EP2023/068502

§ 371 Date: Apr. 9, 2025

(30) Foreign Application Priority Data
Oct. 10, 2022 (EP) 22200486.3

(51) Int. Cl. H02K 3/34; H02K 3/487; H02K 15/108; H02K 15/13

(52) U.S. Cl. CPC H02K 3/345; H02K 3/487; H02K 15/108; H02K 15/13

(57) ABSTRACT

In a method for producing a stator of a dynamoelectric machine, a laminated core which has at least one stator bore, axially running slots and slot openings directed toward the stator bore is stacked. When viewed in a circumferential direction, a slot is formed by two directly adjacent tooth shafts, sections of corresponding tooth heads, the slot opening and a slot base. The slot opening is formed by two opposing end sections of adjacent ones of the tooth heads when viewed in the circumferential direction. The end sections of the tooth heads are coated with an anti-friction coating by a spinning operation or a nozzle. A spinning or spraying device is moved axially within the stator bore during application and thereby provides one slot opening or simultaneously more than one of the slot openings with the anti-friction layer. A winding is drawn into the slots via the slot openings.

The invention relates to a method for producing a stator of a dynamoelectric machine, a stator produced thereby and a dynamoelectric machine provided with such a stator, as well as the use of such a dynamoelectric machine.

Winding systems of dynamoelectric machines, such as for example low-voltage motors, are implemented by means of round wire winding technology. This involves the round wires in bundles being wound into the form of a coil by means of a flyer winder and subsequently drawn into slots of a stator by way of insertion blades.

The stators are in this case axially stacked, in particular punch-stacked, laminations which have radially arranged slots which are directed toward a stator bore and into which the bundles of copper wires are drawn as coils.

Radially inward—that is to say facing a rotor—on the stator there are so-called slot teeth, which are designed in a kind of T shape and this leads to a constriction of the adjoining slots located in between—the slot openings. Created as a result between two slot teeth is the so-called slot gap or slot opening, which represents a constriction in comparison with the rest of the cross section of the slot. During insertion, the copper winding has to be pushed through this constriction, and therefore this constriction represents the “bottleneck” of this technology.

From an electromagnetic viewpoint, a slot opening with a vanishingly small aperture (almost zero, but electrically insulating) would be advisable for the slots of the stator, whereas, from a production engineering viewpoint, however, any constriction of the actual slot geometry leads to difficulties in the aforementioned winding operation.

Up until now, the slot opening has been reduced to the extent allowed by the consequently increasing drawing-in forces on the automatic coil inserting machine and the wire enamel.

Increasing the anti-friction properties of the wire enamel is one possibility here of reducing the drawing-in forces, because it makes it easier for wires that are crossing over to slip off one another and separate.

There is however a limit to increasing the anti-friction properties without sacrificing anything in the later impregnating properties of the winding (the adhesive attachment of the potting compound to such surfaces is extremely inadequate).

Alternative winding insertion technologies (for example the needle winding technique or manual winding) make it possible to use smaller slot gaps. This however leads to increasing production costs of a stator.

It is also possible to reduce the copper filling in the slot, but this is not an advisable option because of the increasing requirements for motor efficiency.

On this basis, the object of the invention is to provide a method for producing a stator which allows automated production of a winding on a stator of a dynamoelectric machine and creates a dynamoelectric machine that has a comparatively high efficiency,

The stated object is achieved by a method for producing a stator of a dynamoelectric machine which comprises the following steps:
stacking a laminated core which has at least one stator bore, axially running slots and slot openings that are directed toward the stator bore, wherein, when viewed in the circumferential direction/cross section, a slot is formed by two directly adjacent tooth shafts, sections of the corresponding tooth heads, the slot opening and a slot base, wherein the slot opening is formed by two opposing end sections of tooth heads that are adjacent when viewed in the circumferential direction,
coating the end sections with an anti-friction coating, in particular an electrically insulating coating,
drawing a winding, in particular a prefabricated winding, in particular a bundle of round wires in the form of a coil, into the slots via the slot openings.

The stated object is also achieved by a stator of a dynamoelectric machine of which the slot openings are coated according to the invention.

The stated object is also achieved by a dynamoelectric machine with a stator according to the invention, wherein the efficiency of the dynamoelectric machine is at least 95%.

The stated object is also achieved by a use of a dynamoelectric machine according to the invention for drives, in particular for drives in continuous operation, such as fans, compressors, pumps, etc.

The coating of end sections of the tooth heads at the slot openings or in the region of the slot openings provides a protective effect with respect to the winding to be drawn in via the slot opening.

Compared with the prior art, in which insertion blades of a blade tool cover the slot openings during the insertion operation of drawing in the winding, there is in fact consequently a reduction of the slot opening due to the coating, but by far not such a great reduction of the slot opening.

These insertion blades, which constrict the respective bundle of wires of the winding locally at the slot opening, are in this case designed such that they are also pushed into the slot aperture as flanks in order to ensure the mechanical protection of the wires from the slot teeth during insertion. This is necessary because the bundle of wires is drawn almost axially along on these and therefore would rub mechanically against the edges of the laminations (which like the individual laminations lie perpendicularly to the direction of movement).

In the standard winding insertion process by means of insertion blades, the protective layer for the bundles of wires is designed as flanks of the blade tool consisting of 0.3 mm stainless steel, which require an additional tolerance in relation to the slot tooth.

These protective flanks of the insertion blades that consist of smooth, polished steel solve this problem, but at the same time they constrict the effective slot gap width by twice the thickness plus a tolerance allowance (typical values are in this case: slot opening: 3.2 mm, constriction:
2×0.3 mm blade thickness+0.4 mm (tolerance and “blade clearance”)=1 mm), that is to say in the specific case by about 30%, In the prior art, the slot opening is therefore specifically reduced as follows. The flanks of the insertion blades protruding into the slot opening are on each side 0.3 mm wide, with allowance also being required for a tolerance of 2×0.1 mm in relation to the slot tooth. Therefore, an overall slot-opening loss of 0.8 mm+0.2 mm (additional “blade clearance”), thus of 1 mm, must be expected here.

According to the invention, the protective effect of the insertion blades of the blade tool is therefore replaced by an applied coating on the end sections. This coating may be applied additively, preferably sprayed, so that flanks of the blade tool reaching into the slot opening are no longer necessary on the end sections.

At a time before the winding Insertion process, according to the invention a layer of plastic is applied at least at the end face to the end sections of the slot teeth, covering the lamination contours (at the end face, individual laminations with lamination edges). It is important here that the applied layer of plastic covers at least the lamination edges. A continuous and smooth, uninterrupted surface of plastic is not absolutely necessary, but is advisable in order to improve the sliding friction during the insertion process, i.e. further reduce the drawing-in forces.

In this case, the coating is at most 50 μm thick. The slot opening is therefore reduced far less, which facilitates the insertion operation, in particular reduces the necessary drawing-in forces of the blade tool. Furthermore, it is also possible for winding wires with larger diameters to be used.

The applied coating must therefore only be a few um to at most 50 μm thick in order to ensure statistically that all of the lamination edges are coated at least with a few um of plastic, so that an enameled wire of the winding sliding past during insertion does not suffer any mechanical damage, in particular scratches on its insulation.

Typical coatings of plastic suitable for this are in this case thermosetting lacquers (for example PEI, PU, epoxy, polysiloxanes, polysilazanes ...) , which, diluted by means of solvents, can be sprayed in thin layers and, due to the use of two-component materials, cure within a few hours at room temperature. This time period can be additionally shortened by gentle heating (for example 70 °C for a few hours).

A further variant for the application of a thin layer of plastic is the use of soluble thermoplastics, such as for example PEG, PVP or PVA, which, after drying of the solvent, within a short time provide a physically dried layer and therefore produce a protective film of the aforementioned thickness. In this case, products with high molecular weights are used, at least reaching the later insulation class of the motor.

A further possibility for obtaining such a layer is to use high-melting waxes and high-molecular weight greases, which can then likewise be sprayed on at high temperatures (for example >250 °C) and, due to the instantaneous cooling, offer a protective film.

A further possibility is to use high-melting thermoplastic hotmelt adhesives (for example PA), which are propelled by being spun (sprayed) in the form of a flying helix onto the substrate by way of a rotary nozzle, cool down on impact with the end sections and solidify into a layer. A wide variety of different spray patterns (closed, porous), layer thicknesses and adhesive attachment characteristics can be achieved here by way of the temperature of the material, temperature of the compressed air, pressure, nozzle geometry, etc. The cooled-down surface subsequently has similar anti-friction properties to a smooth thermoplastic housing.

In addition, anti-friction fillers can be added to the aforementioned plastics as additives which further improve the sliding friction of the layer of plastic and, as long as the additives are provided with a form factor (that is to say are in the form of platelets or rods), can bridge gaps between two axially adjacent laminations. Possible, commonly used anti-friction additives are in this case BN, graphite and PTFE, which are added to the polymer matrix in a percentage by volume of between 1 and 25%.

The sprayed-on coating has the effect that, in principle irrespective of the composition of the layer, then only a reduction of at most 2×50 μm is imparted to the slot opening.

Therefore, in the aforementioned example, the slot tooth can be advantageously widened to the minimum necessary slot aperture, which is determined by the wire used, because the bundles of wires can slide along on the sprayed-on coating without being damaged at the lamination edges.

The protective function of the bundle of wires during the insertion of the winding into the slot via the slot opening is achieved according to the invention by an anti-friction coating, which acts as a separating layer. This can be significantly thinner and does not need any tolerance allowance with respect to the insertion blades protruding into the slot opening, as a result of which the effective slot tooth width, and therefore the efficiency of the motor, can be increased without reducing the effective slot opening when inserting the winding by standard means.

The method according to the Invention for producing a stator of a dynamoelectric machine can thus dispense with the flanks of the insertion blades, especially in the slot opening, without at the same time having to fear any damage to the wire enamel of the winding during insertion.

The coating according to the invention of the slot opening therefore allows a correspondingly larger slot tooth, or slot tooth that is wider when viewed in the circumferential direction, with a comparatively smaller slot opening width, which increases the efficiency of a dynamoelectric machine by up to one percentage point.

Among the effects of the coating according to the invention of the slot openings of the stator is therefore correspondingly larger tooth heads, or tooth heads that are wider when viewed in the circumferential direction, with a comparatively smaller slot opening width, which increases the efficiency of a dynamoelectric machine with such a stator by up to one percentage point.

This is particularly advantageous especially in the case of drives, in particular in the case of drives in continuous operation such as fans, compressors, pumps, etc.

The invention and further advantageous designs of the invention are explained in more detail on the basis of exemplary embodiments shown in principle in the drawings, in which:

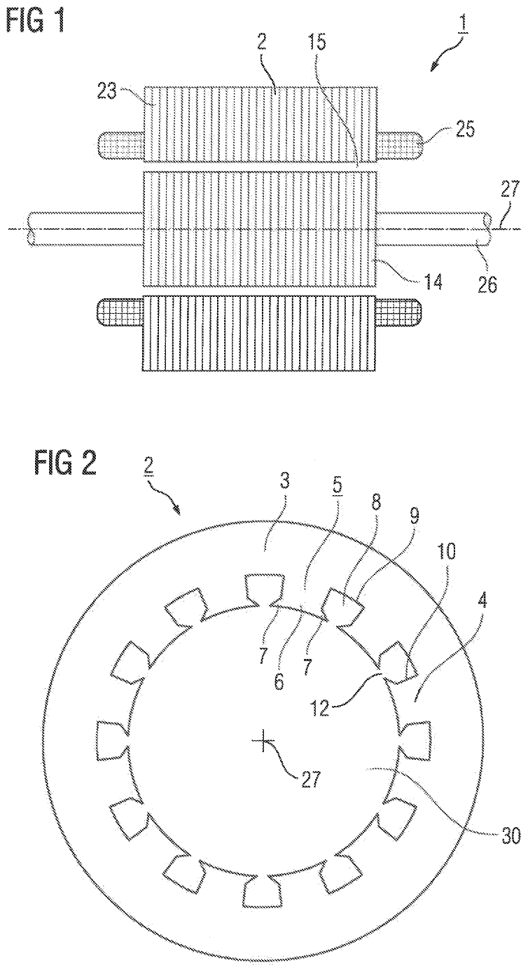

FIG. 1 shows a basic longitudinal section of a dynamoelectric machine,

FIG. 2 shows a basic cross section of a stator,

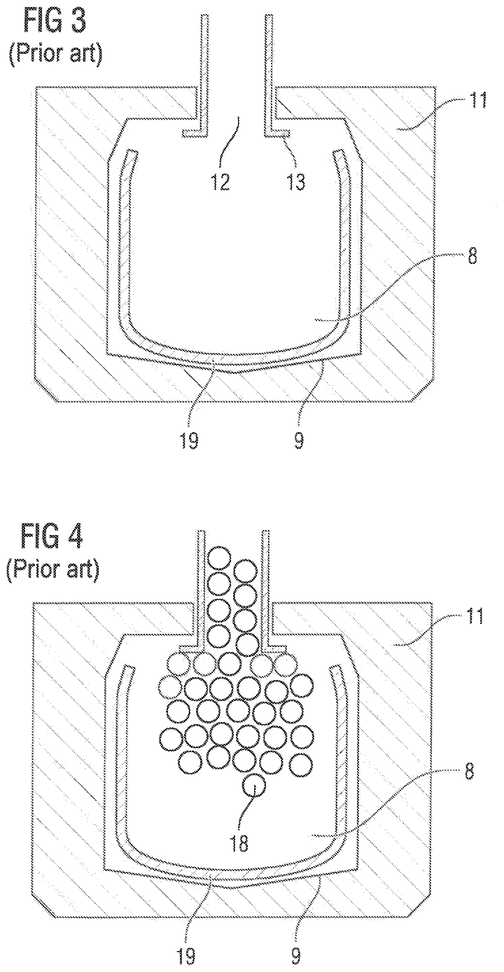

FIGS. 3 to 5 show the insertion technique according to the prior art,

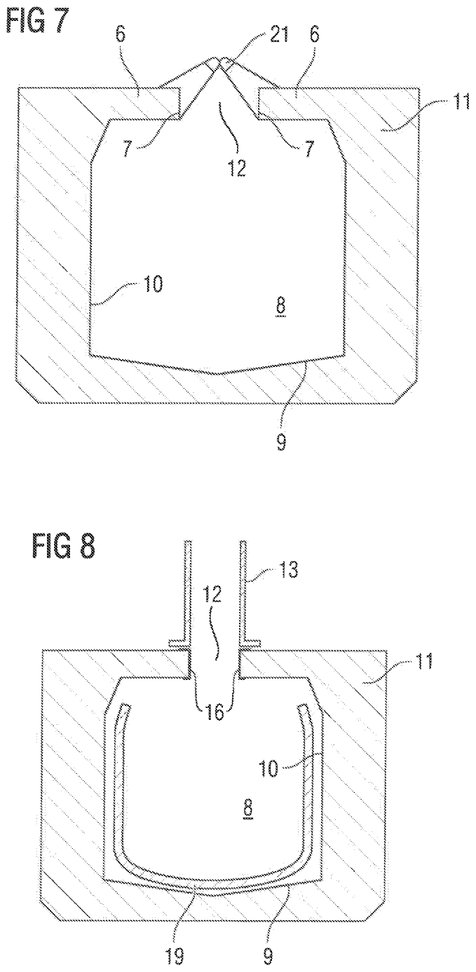

FIGS. 6 and 7 show a basic representation of the spraying process,

FIGS. 8 to 10 show a basic representation of the method according to the invention,

FIG. 11 shows a cutout from a laminated core,

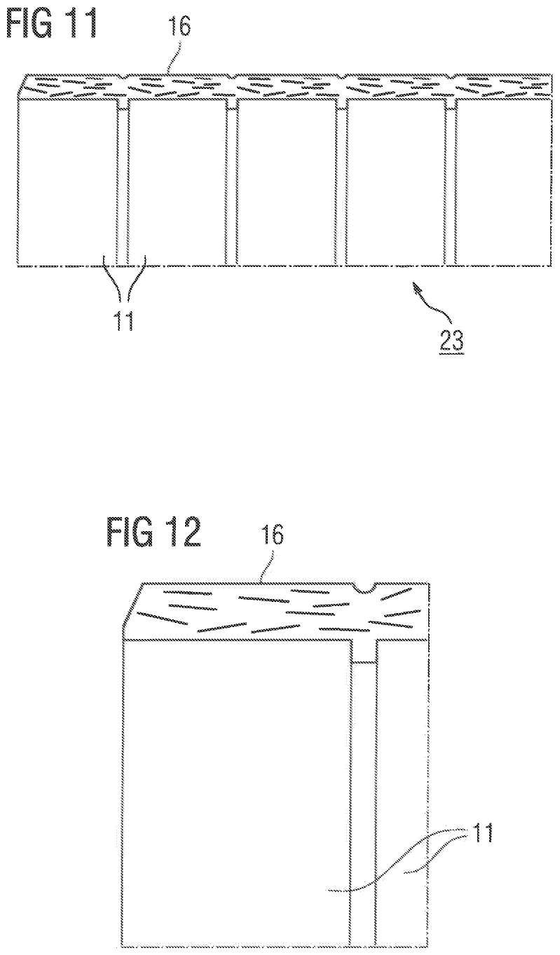

FIG. 12 shows a view of a detail of the cutout of the laminated core,

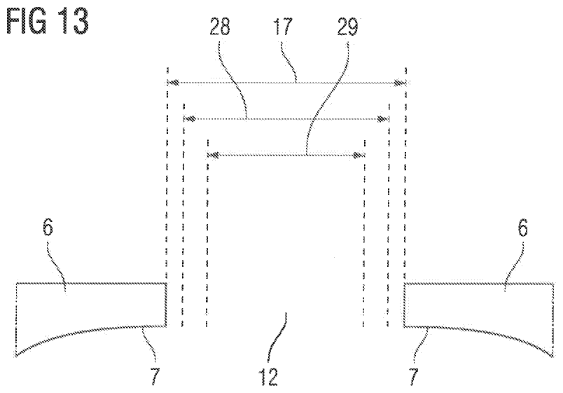

FIG. 13 shows a view of a detail of the slot opening.

It should be noted that terms such as “axial”, “radial”, “tangential” etc. refer to the axis 27 used in the respective FIG or in the example described in each case. In other words: the directions axial, radial, tangential always refer to an axis 27 of the rotor 14 and thus to the corresponding axis of symmetry of the stator 2.

In this case, “axial” describes a direction parallel to the axis 27, “radial” describes a direction orthogonal to the axis 27, toward or away from it, and “tangential” is a direction that is at a constant radial distance from the axis 27 and, in the case of a constant axial position, directed in a circular manner around the axis 27. The expression “in the circumferential direction” is equivalent to “tangential”.

In relation to a surface, for example a cross-sectional surface, the terms “axial”, “radial”, “tangential” etc. describe the orientation of the normal vector of the surface, i.e. the vector that is perpendicular to the surface concerned.

The expression “coaxial components”, for example coaxial components such as the rotor 14 and the stator 2, is understood here as meaning components that have the same normal vectors, that is to say for which the planes defined by the coaxial components are parallel to one another. Furthermore, the expression is intended also to convey that the center points of coaxial components lie on the same axis of rotation or axis of symmetry. However, these center points may possibly lie at different axial positions on this axis and the planes mentioned may be at a distance of >0 from one another. The expression does not necessarily require that coaxial components have the same radius.

The term “complementary” in connection with two components that are “complementary” to one another means that their outer forms are designed in such a way that the one component can preferably be arranged completely in the component complementary to it, so that the inner surface of one component and the outer surface of the other component ideally touch without any gaps or over the entire surface area. Consequently, in the case of two objects that are complementary to one another, the outer form of one object is determined by the outer form of the other object. The term “complementary” could be replaced by the term “Inverse”.

For the sake of clarity, sometimes in cases where components are multiply present, in the figures often not all the components shown are provided with reference signs.

The described embodiments can be combined as desired. Similarly, Individual features of the respective embodiments can be combined without departing from the essence of the Invention.

FIG. 1 shows a basic representation of a dynamoelectric machine 1 in a longitudinal section. A stator 2, formed from axially stacked laminations 11, has a rotor 14 in its stator bore 30. A laminated core 23 is stacked, in particular punch-stacked, from individual laminations 11. The stator 2 and the rotor 14 are spaced apart from one another by an air gap 15. Provided on an inside wall of the stator bore 30 are slots 8, which run substantially axially and form a slot opening 12 in the direction of the air gap 15.

The slots 8 of the stator 2 and/or slots of the rotor 14 run axially parallel or are skewed from one end face to the other end face by up to two or three slot pitches.

The rotor 14 is connected to the shaft 26 for conjoint rotation and is mounted rotatably about an axis 27. The slot openings 12 of the slots 8 are used during the production of the stator 2 for drawing a winding system 25, in particular a bundle of wires formed as coils, into the respective slots 8 via the slot openings 12 by means of a blade tool. During the insertion operation, the wire Insulation of these coils is at risk of being scratched on the edges of the slot openings 12, thereby impairing the insulating properties of the wires.

FIG. 2 shows the stator 2 in a basic cross section with its stator bore 30, its yoke rear 3 and the slots 8 directed toward the axis 27. In this case, a slot 8 has a slot base 9, slot walls 10 and also a slot opening 12. The slot 8 is therefore created by teeth 5 that are adjacent when viewed in the circumferential direction. The slot wall 10 is in this case arranged in the region of the tooth shaft 4, and the tooth heads 6, in particular their end sections 7, form the slot opening 12. A winding system 25 is positioned in the slot 8 via the slot opening 12, and consequently along the end sections 7 of the adjacent tooth heads 6. Damage to an insulation of the wires of the winding system 25 may occur in this region during an insertion operation.

As can be seen in principle from FIG. 1 to FIG. 4, according to the prior art the winding 25 is for this reason introduced into the slot 8 in the following way.

First, according to FIG. 3, the insertion blades or flanks of the blade tool 13 are positioned in the slot opening 12, in order to ensure the mechanical protection of the wires from the slot teeth, especially their end sections, during insertion. This makes it possible for the respective bundle of wires to be locally constricted according to FIG. 4. This is necessary because the bundle of wires of the winding system 25 is drawn over the slot opening 12, and thereby almost axially along these slot teeth 5, for positioning in the slot 8. Therefore, damage to the insulation of the wires during insertion is avoided by the insertion blades at the slot opening 12, with the insertion taking place perpendicularly to the axial stacking of the laminated core 23 or perpendicularly to the direction of movement of the blade tool 13.

This problem is solved by protective flanks of the insertion blades, which consist of smooth, polished steel. A disadvantage here is that the effective width of the slot opening is reduced considerably, (typical values: slot opening: 3.2 mm, constriction: 2×0.3 mm blade thickness+0.4 mm (tolerance and “blade clearance”)=1 mm), that is to say in the specific case by about 30%.

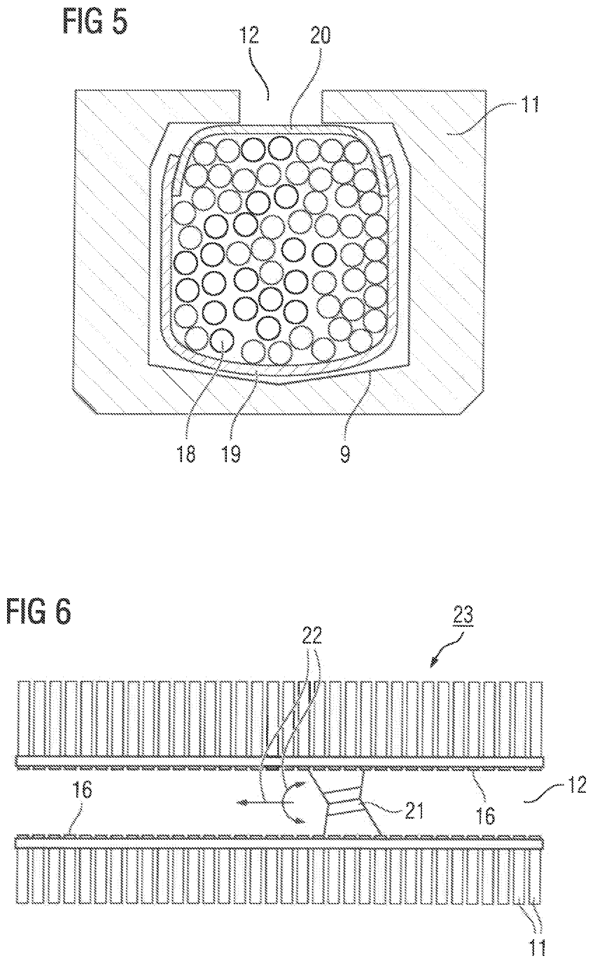

According to the invention, therefore—in order to obtain a slot 8 with a winding system 25 according to FIG. 5—according to FIG. 6 a coating 16 is applied to the end sections of the tooth heads 6—that is to say in the region of the slot opening 12. This may be performed for example by a spraying tool 21, which moves along one or more slot openings 12 by an axial movement with overlaid rotation.

The edges of the end sections 7 are thereby coated according to FIG. 7. In this case, both the corners of the end sections 7 (directed toward the slot and toward the air gap) and their preferably parallel flanks are coated.

This coating, which provides the protective effect of the insertion blades, is applied additively, preferably sprayed. The stainless steel flanks of the blades are 0.3 mm, with allowance being made for a tolerance of 2×0.1 mm in relation to the tooth head 6. Therefore, an overall slot-opening loss of 0.8 mm+0.2 mm additional “blade clearance” must be expected.

Thus, according to FIG. 8, for the insertion process of drawing in the winding 25, the blades of the blade tool 13 therefore interlockingly engage adjacent tooth heads 6, that is to say the coated slot opening 12 on the side of the stator bore 30. The slots 8 are in this case provided with a slot lining 19, that is to say a slot cell, usually a PET multilaminate with aramid felt, of a thickness of about 300 μm.

Preferably, the adjoining blades and the coated slot opening 12 have the same width.

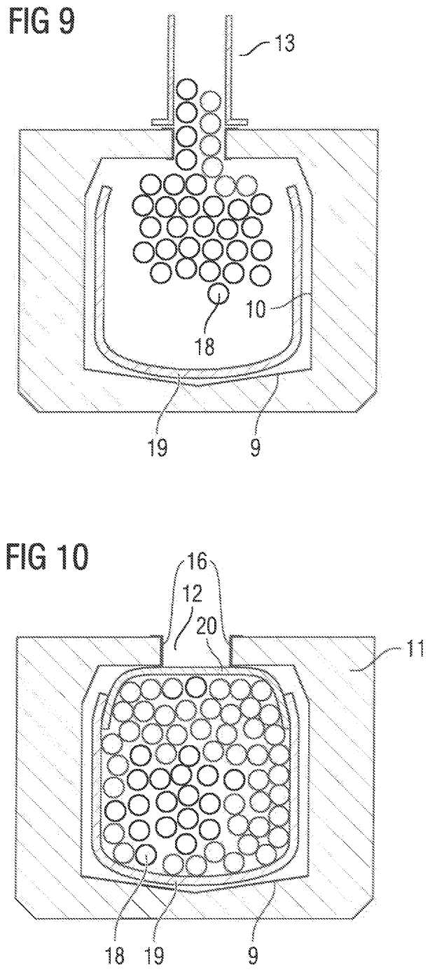

After that, the insertion operation of drawing the winding 25 according to FIG. 9 into the slot 8 is performed via the comparatively wide slot opening 12.

The coating 16 stays on the slot opening 12. After the insertion of the winding 25 via the slot opening 12, the slot 8 is covered by a cover slide 20 according to FIG. 10. Subsequently, a winding overhang is formed at both end faces of the stator 2 and the stator 2 is potted.

The laminated core 23 of the stator 2 has stack tolerances, which are manifested by comparatively small gaps and edges between the individual laminations 11, but also on the tooth heads 6 of the end sections 7.

The coating 16 compensates for these gaps and edges or possible stack tolerances and covers lamination edges according to FIG. 11. This leads to a significant reduction in the macroscopic surface roughness, which ideally, but not absolutely necessarily, forms a continuously smooth surface. The contour may also form shallow arcs in the region of the gaps and edges, according to FIG. 11 and FIG. 12. The reduction in the microscopic surface roughness is determined by the choice of the polymer and its filler additives.

At a time before the winding insertion process, therefore, a layer of plastic is applied at least at the end face to the end sections 7 of the teeth 6, covering the lamination contours (at the end face, individual laminations with lamination edges). It is important here that the applied layer of plastic covers at least the lamination edges for the following insertion operation of drawing in the winding 25. A continuous and smooth, uninterrupted surface of plastic is not absolutely necessary here, but is advisable in order to improve the sliding friction during the insertion process, Le. further reduce the drawing-in forces.

In this case, the coating 16 in the aforementioned regions is at most 50 μm thick. The slot opening 12 is therefore constricted far less, which facilitates the insertion operation, in particular reduces the necessary drawing-in forces of the blade tool. Furthermore, it is also possible for winding wires with larger diameters to be used.

The applied coating 16 must therefore only be a few um to at most 50 μm thick in order to ensure statistically that all of the lamination edges are coated at least with a few um of plastic, so that a wire of the winding 25, in particular an enameled wire of the winding, sliding past during insertion does not suffer any mechanical damage, in particular scratches on its insulation.

Suitable coatings of plastic are in this case thermosetting lacquers (for example PEI, PU, epoxy, polysiloxanes, polysilazanes, etc.), which, diluted by means of solvents, can be sprayed in thin layers and, due to the use of two-component materials, cure within a few hours at room temperature. This time period can be additionally shortened by gentle heating (for example 70 °C for a few hours).

A further variant for the application of a thin layer of plastic is the use of soluble thermoplastics, such as for example PEG, PVP or PVA, which, after drying of the solvent, within a short time provide a physically dried layer and therefore produce a protective film of the aforementioned thickness. In this case, products with high molecular weights are used, at least reaching the later insulation class of the motor 1.

A further possibility for obtaining such a layer is to use high-melting waxes and high-molecular-weight greases, which can then likewise be sprayed on at high temperatures (for example >250 °C) and, due to the Instantaneous cooling, offer a protective film.

A further possibility is to use high-melting thermoplastic hotmelt adhesives (for example PA), which are propelled by being spun (sprayed) in the form of a flying helix onto the substrate by way of a rotary nozzle of a spraying tool 21, cool down on impact with the end sections and solidify into a layer. A wide variety of different spray patterns (closed, porous), layer thicknesses and adhesive attachment characteristics can be achieved here by way of the temperature of the material, temperature of the compressed air, pressure, nozzle geometry, etc. The cooled-down surface subsequently has similar anti-friction properties to a smooth thermoplastic housing.

In addition, anti-friction filler additives which further improve the sliding friction of the coating 16 and, as long as the additives are provided with a form factor (that is to say are in the form of platelets or rods), bridge gaps between two axially adjacent laminations 11 in the laminated core 23 can be added to the aforementioned plastics. Possible, commonly used anti-friction additives are in this case BN, graphite and PTFE, which are added to the polymer matrix in a percentage by volume of between 1 and 25%.

The sprayed-on coating 16 has the effect that, in principle irrespective of the composition of the layer, then only a reduction of at most 2 x 50 um is imparted to the slot opening 12.

Therefore, in the aforementioned example, the tooth head 6 can be widened to the minimum necessary width of the slot opening 12, which is determined inter alia by the wire used, because the bundles of wires can slide along on the sprayed-on coating 16 without being damaged at the lamination edges.

The protective function of the bundle of wires during the insertion of the winding into the slot 8 via the slot opening 12 is achieved according to the invention by the coating 16, which acts as a separating layer. This can be significantly thinner and does not need any tolerance allowance with respect to the insertion blades protruding into the slot opening 12, as a result of which the effective slot tooth width, and therefore the efficiency of the motor, can be increased without reducing the effective slot opening when inserting the winding by standard means.

FIG. 13 shows a slot opening 12 given by way of example, which is formed by the end sections 7 of the tooth heads 6 that are adjacent when viewed in the circumferential direction. In this case, the maximum possible width 17 of the slot opening 12. The blades reaching through the blade tool into the slot opening 12 reduce the width of the slot opening 12 to the blade width 29. In contrast, the coating 16 according to the invention only causes the width of the slot opening 12 to be reduced to the coating width 28.

In a method according to the invention for producing a stator 2 of a dynamoelectric machine 1, it is thus possible to dispense with the flanks of the insertion blades, especially in the slot opening 12, without at the same time having to fear any damage to the wire enamel of the winding during insertion.

The coating 16 according to the invention of the slot openings 12 therefore allows correspondingly larger tooth heads 6, or tooth heads that are wider when viewed in the circumferential direction, with a comparatively smaller slot opening width, which increases the efficiency of a dynamoelectric machine 1 by up to one percentage point.

What is claimed is:

1.-10. (canceled)

11. A method for producing a stator of a dynamoelectric machine, the method comprising:
stacking a laminated core which has at least one stator bore, axially running slots and slot openings that are directed toward the stator bore, wherein, when viewed in a circumferential direction, a slot is formed by two directly adjacent tooth shafts, sections of corresponding tooth heads, the slot opening and a slot base, wherein the slot opening is formed by two opposing end sections of adjacent ones of the tooth heads when viewed in the circumferential direction;
coating the end sections of the tooth heads with an anti-friction coating, in particular an electrically insulating coating, by a spinning operation or a nozzle, in particular a rotary nozzle, wherein a spinning or spraying device is moved axially within the stator bore during application and thereby provides one slot opening or simultaneously more than one of the slot openings with the anti-friction layer; and
drawing a winding, in particular a prefabricated winding, in particular a bundle of round wires in the form of a coil, into the slots via the slot openings.

12. The method of claim 11, wherein the anti-friction layer is sprayed on the end sections as diluted thermosetting lacquers.

13. The method of claim 11, wherein the anti-friction layer is applied to the end sections as soluble thermoplastics.

14. The method of claim 11, wherein the anti-friction layer is sprayed on the end sections by high-melting waxes or greases.

15. The method of claim 11, wherein the anti-friction layer is applied to the end sections by a thermoplastic hotmelt adhesive.

16. The method of claim 11, wherein the winding is drawn into one or more slots by a blade tool, the method further comprising engaging the blade tool on a stator-bore-facing side of the slot opening.

17. A stator of a dynamoelectric machine, the stator comprising:
a laminated core including at least one stator bore, axially running slots and slot openings that are directed toward the stator bore, wherein, when viewed in a circumferential direction, a slot is formed by two directly adjacent tooth shafts, sections of corresponding tooth heads, the slot opening and a slot base, wherein the slot opening is formed by two opposing end sections of adjacent ones of the tooth heads when viewed in the circumferential direction;
a winding, in particular a prefabricated winding, in particular a bundle of round wires in the form of a coil, into the slots via the slot openings; and
a coating for coating the slot opening, said coating being a coating of plastic with a thickness of a few um to at most 50 μm.

18. The stator of claim 17, wherein the slot opening corresponds to x times a wire diameter of the winding, where x>1.

19. The stator of claim 17, wherein the coating is made of diluted thermosetting lacquers.

20. The stator of claim 17, wherein the coating is made of soluble thermoplastics,

21. The stator of claim 17, wherein the coating is made of high-melting waxes or greases.

22. The stator of claim 17, wherein the coating is made of a thermoplastic hotmelt adhesive.

23. A dynamoelectric machine, comprising the stator of claim 17, wherein an efficiency of the dynamoelectric machine is at least 95%.

24. The dynamoelectric machine of claim 23 for use in a drive, in particular drives in continuous operation such as fans, compressors, pumps, etc.
